(19) United States
(12) Patent Application Publication
(10) Pub. No.: US 2009/0128410 A1
(43) Pub. Date: May 21, 2009

(54) Method, apparatus and computer readable medium providing power allocation for beamforming with minimum bler in an MIMO-OFDM system

(75) Inventor: Shaohua Li, Beijing (CN)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/985,875

(22) Filed: Nov. 15, 2007

(51) Int. Cl. H04B 1/00

(52) U.S. Cl. 342/367

(57) ABSTRACT

A method for allocating power for beamforming is described. The method includes selecting a number of data streams to be employed. Power for beamforming is allocated to the selected number of data streams based upon the effective SINR and in consideration of a FEC code. The allocation of power may be based upon maximizing the effective SINR. Additionally, the method may include determining an effective SINR using an EESM procedure. An apparatus, computer readable medium and system are also described.

### TECHNICAL FIELD

The exemplary embodiments of this invention relate generally to wireless communication systems and, more specifically, relate to power allocation for beamforming.

### BACKGROUND

The following abbreviations are utilized herein:
AN access node
AWGN additive white Gaussian noise
BER bit error rate
BLER block error rate
BS base station
CSI channel state information
EESM exponential effective SINR mapping
E-UTRA evolved UMTS terrestrial radio access
E-UTRAN evolved UMTS terrestrial radio access network
FEC forward error correct
HARM harmonic mean SNIR
i.i.d. independent identically distributed
LTE long term evolution
MCS modulation and coding scheme
MI-ESM mutual information effective SINR mapping
MIMO multi-input multiple-output
OFDM orthogonal frequency division multiplexing
SINR signal to noise and interference ratio
SNR signal to noise ratio
SS subscriber station
SVD singular value decomposition
UE user equipment
UMTS universal mobile telecommunications system
UTRAN UMTS terrestrial radio access network
UTRAN-LTE universal terrestrial radio access network-LTE
UWB ultra wide band

Multiple-input multiple-output (MIMO) has the potential for achieving a high data rate and providing more reliable reception performance. Orthogonal frequency division multiplexing (OFDM) can be used to make wideband frequency-selective channels to be a number of parallel narrowband sub-channels by splitting one data stream into several parallel streams. As a result, the combination of MIMO and OFDM can be used to provide many options in space, time and frequency. MIMO-OFDM systems are promising candidates for several wireless systems, such as 3GPP LTE, 802.16, 4 G wireless systems, ultra wide band (UWB) and cognitive radio systems.

Currently, the standardization of Long Term Evolution (LTE), also known as 3.9 G, is being considered. The LTE is capable of delivering wireless broadband access at high bit rates similar to or higher than the rates offered in fixed (e.g., wired) networks. LTE is built as a flexible network with different frequencies and corresponding bandwidths. This means that different kind of networks can be built inside LTE with different network capacities (e.g., in terms of bit rate, loading, etc). For example, LTE (10 MHz) or LTE (20 MHz), can be offered according to the demands of high bit rate and capacity.

Recently, an increasing interest has been given to space-time smart antennas to improve the performance of communication link and the capacity of scatter wireless channels while maintaining the required transmitted power and bandwidth. By splitting a broadband channel into multiple narrow channels, OFDM is robust to frequency selective fading and narrow band interference. As a result, MIMO-OFDM has been considered as the main candidate for future communication systems.

One of the disadvantages of OFDM is sub-channel domination. In an uncoded OFDM system with a fixed modulation scheme for all the channels, the error probability of the whole system is dominated by the subchannel with the highest attenuation. If the SINR fluctuates over subchannels, the ones with the worst SINR would affect the overall BER the most.

In MIMO-OFDM systems, when channel state information (CSI) is available at the transmitter and the receiver, joint beamforming strategies can be applied to maximize the signal-to-noise and interference ratio (SNIR) by choosing the best spatial sub-channel or eigenmode for transmission. At present, an effective beamforming scheme may be one of the most important close loop MIMO technologies in IEEE 802.16e and LTE.

With beamforming, allocating the power for each subcarrier is an important task in OFDM systems. Some power allocation schemes for beamforming have been proposed. However, for these schemes, no forward error correct (FEC) code is considered. For additional details on a beamforming scheme see Qinghua Li, et al., “Improved Feedback for MIMO Precoding”, IEEE C802.16e-2004/527r4. The described beamforming scheme is also the main beamforming scheme in IEEE Std 802.16e-2004.

Conventionally, minimum raw bit error rate (BER) criteria or SINR criteria may be used when FEC code is not considered. As a result, information BLER is not minimized based on these criteria. However, for a practical system, information BLER is much more important than raw BER.

In A. Pascual-Iserte, A. I. Perez-Neira, and M. A. Lagunas, “On power allocation strategies for maximum signal to noise and interference ratio in an OFDM-MIMO system”, Wireless Communications, IEEE Transactions on, vol. 3, pp. 808-820, 2004, two power allocation schemes were proposed: one is based on the maximization of the harmonic SINR mean (HARM), and the other is based on the maximization of the minimum SINR over the subcarriers. The main problem is that these schemes don't consider the FEC code. Because of this, the BER may be minimized, but the information block error rate (BLER) is not.

In T. Keller and L. Hanzo, “Adaptive multicarrier modulation: a convenient framework for time-frequency processing in wireless communications”, Proceedings. of the IEEE, vol. 88, pp. 611-640, 2000, a power allocation scheme based on bit loading is proposed. In that scheme, some of the subcarriers may be nulled. In that case, the optimum strategy should transmit the information symbols through the remaining active carriers if the throughput is to be maintained. The main problem is that the transmitter must then increase the signaling messages to the receiver to inform the receiver about the new bit loading situation. It is the extra signaling messages that cause only one modulation and coding scheme (MCS) to be employed in one minimum resource block, e.g., one slot in IEEE 802.16e, in practical systems. Therefore, this scheme can improve system throughput in theory, but it is not practical.

### SUMMARY

An exemplary embodiment in accordance with this invention is a method for allocating power for beamforming. The method includes selecting a number of data streams to be employed for the beamforming. Power for beamforming is allocated to the selected number of data streams based upon an effective SINR and in consideration of a FEC code.

In further embodiments the allocation of power is also based upon maximizing the effective SINR. The method may include selecting a MCS based upon channel state information. An adjust parameter is selecting based upon the selected MCS and power allocating is also based upon the selected adjust parameter. Additionally, the method may include determining an effective SINR using an EESM procedure.

Furthermore, the method may include receiving an indication of a beamforming matrix. Channel state information may be determined from the received indication. The effective SINR is based upon the channel state information. The indication of the beamforming matrix may include the K strongest eigenmodes and the K strongest eigenvalues of the beamforming matrix, where K is the number of data streams employed. The allocating of power may also be based upon the K strongest eigenvectors of the beamforming matrix.

An additional exemplary embodiment in accordance with this invention is an apparatus for allocating power for beamforming. The apparatus includes a component configured to select a number of data streams to be employed for beamforming. A power allocating component is included and is configured to allocate power to the selected number of data streams based upon an effective SINR and in consideration of a FEC code.

In further embodiments the allocation of power is also based upon maximizing the effective SINR. The apparatus may include a receiver to receive an indication of a beamforming matrix. Channel state information may be determined from the received indication. The effective SINR is based upon the channel state information. The indication of the beamforming matrix may include the K strongest eigenmodes and the K strongest eigenvalues of the beamforming matrix, where K is the number of data streams employed. The allocating of power may also be based upon the K strongest eigenvectors of the beamforming matrix.

A further exemplary embodiment in accordance with this invention is an apparatus for allocating power for beamforming. The apparatus includes a means for selecting a number of data streams to be employed for the beamforming. A means for allocating power to the selected number of data streams allocates power based upon an effective SINR and in consideration of a FEC code. The determining means and the allocating means may be processors.

An additional exemplary embodiment in accordance with this invention is a computer readable medium embodied with a computer program. The computer program includes program instructions for allocating power for beamforming. The program instructions include selecting a number of data streams to be employed for the beamforming. The program instructions provide for allocating power for beamforming to the selected number of data streams based upon an effective SINR and in consideration of a FEC code.

In further embodiments the allocation of power is also based upon maximizing the effective SINR. The program instructions may include selecting a MCS based upon channel state information. An adjust parameter is selecting based upon the selected MCS and power allocating is also based upon the selected adjust parameter. Additionally, selecting the adjust parameter may be further based upon a simulation.

Furthermore, the program instructions may provide for receiving an indication of a beamforming matrix. Channel state information may be determined from the received indication. The effective SINR determination is further based upon the channel state information. The indication of the beamforming matrix may include the K strongest eigenmodes and the K strongest eigenvalues of the beamforming matrix, where K is the number of data streams employed. The allocating of power may also be based upon the K strongest eigenvectors of the beamforming matrix.

A further exemplary embodiment in accordance with this invention is a system for allocating power for beamforming. The system includes a mobile station and a network element.

The mobile station includes a channel matrix an estimating component to estimate a channel matrix. A beamforming matrix generating component generates a beamforming matrix based upon the channel matrix. A transmitter transmits an indication of the beamforming matrix. The network element includes a receiver to receive an indication of a beamforming matrix. Channel state information may be determined from the received indication. A component configured to select a number of data streams to be employed for beamforming is included. A power allocating component is configured to allocate power to the selected number of data streams based upon an effective SINR and in consideration of a FEC code. The effective SINR is based upon the channel state information.

In a further embodiment of the system, the indication of the beamforming matrix may include the K strongest eigenmodes and the K strongest eigenvalues of the beamforming matrix, where K is the number of data streams employed. The allocating of power may also be based upon the K strongest eigenvectors of the beamforming matrix. Additionally the system may be a MIMO-OFDM system.

### BRIEF DESCRIPTION OF THE DRAWINGS

In the attached Drawing Figures:

FIG. 1 shows a simplified block diagram of various electronic devices that are suitable for use in practicing the exemplary embodiments of this invention;

FIG. 2 shows a simplified block diagram of an UE and an AN that are suitable for use in practicing the exemplary embodiments of this invention;

FIG. 3 illustrates an exemplary channel matrix for the block diagram shown in FIG. 2; and

FIG. 4 is a logic flow diagram of an exemplary method in accordance with this invention.

### DETAILED DESCRIPTION

As shown above, one of the disadvantages of OFDM is sub-channel domination. If the SINR fluctuates over the subchannels, the ones with the worst SINR would affect the overall BER the most. As a result, in the case of frequency selective fading channels, the performance of the whole system, in terms of error probability, will improve slowly by increasing the transmitted power. In order to obtain a minimum overall error probability, the power allocation should be optimized in a fixed total power policy. Exemplary embodiments in accordance with this invention provide a method to correct these problems.

The exemplary embodiments in accordance with this invention provide a power allocation scheme for beamforming based on an exponential effective SINR mapping (EESM) scheme. In such a scheme the BLER can be minimized. By changing adjust factor β, the power allocation scheme can be employed in almost all the generally used MCSs.

With an EESM scheme the effective SINR can be obtained. Information BLER is a monotone decreasing function along with effective SINR in the concerned region. The maximization of effective SINR is equivalent to the minimization of information BLER. Therefore, with this invention minimization of the information BLER can be achieved. The closed-form for the power allocation is given.

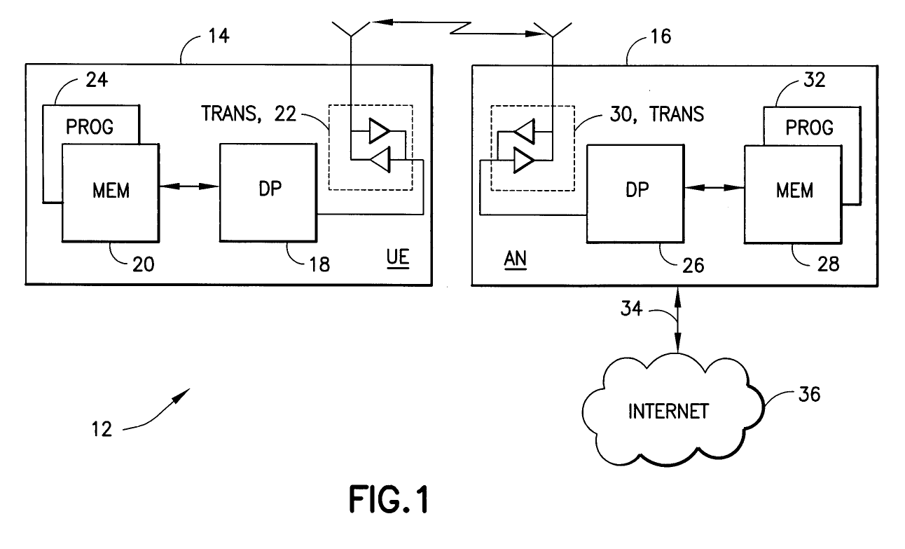

Reference is made to FIG. 1 for illustrating a simplified block diagram of various electronic devices that are suitable for use in practicing the exemplary embodiments of this invention. In FIG. 1, a wireless network 12 is adapted for communication with a user equipment (UE) 14 via an access node (AN) 16. The UE 14 (sometimes referred to as a subscriber station (SS) or mobile station (MS)) includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 may have multiple antennas to facilitate communication.

The AN 16 (which may be a base station (BS)) includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

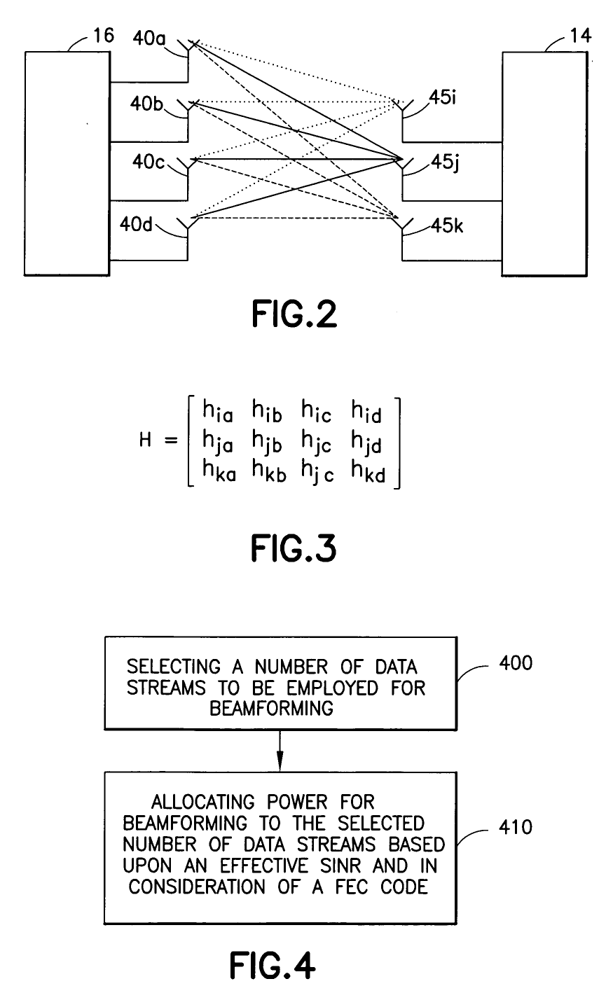

FIG. 2 shows a simplified block diagram of UE 14 and an AN 16 that are suitable for use in practicing the exemplary embodiments of this invention. In the MIMO system shown, the TRANS 22 of the UE 14 has three (3) antennas: 45i, 45j and 45k. The TRANS 30 of the AN 16 is shown with four (4) antennas: 40a, 40b, 40c and 40d. These are non-limiting examples and the number of antennas may vary.

A channel matrix may be generated representing complex channel gains between each transmit and receive antenna pair. The channel matrix for the system shown in FIG. 2 could be represented as a 3×4 matrix. Such a matrix is show in FIG. 3. Here, h_{xy} represents the complex channel gain between the x antenna on the UE 14 and the y antenna on the AN 16.

When FEC code is considered in an OFDM system, an effective SINR criterion is more efficient than traditional SINR and raw BER criteria. Conventional SINR and raw BER characterization of fading channel performance lacks generality, since the same SINR and raw BER value may lead to drastic block error rate differences. As a result, effective SINR can be widely used in system evaluations. Effective SINR can be obtained based upon EESM and mutual information effective SINR mapping (MI-ESM) Compared with MI-ESM, EESM has a closed-form and may be easier to implement.

In an exemplary embodiment of this invention, a scheme allocates the power for beamforming based on effective SINR criteria when FEC code is employed, where effective SINR is obtained with EESM. The closed-form for the power allocation can thus be obtained. Some example FEC codes include: turbo codes, convolutional codes (CC) and low density parity check codes (LDPC).

In an exemplary embodiment in accordance with this invention the system is equipped with Mᵣ receive antennas and Mₜ transmit antennas, and each OFDM has N subcarriers. The matrix Hₙ denotes the Mᵣ×Mₜ channel matrix in the nth subcarrier, the corresponding received signal is given as:

$${x}_{n} = \sqrt{\frac{{E}_{s}}{{M}_{t}}} {H}_{n} {Θ}_{n} {P}_{n}^{1 / 2} {s}_{n} + {w}_{n} \qquad ( 1 )$$

where xₙ is an Mᵣ×1 matrix; the noise vector w⁽ⁿ⁾ is an Mᵣ×1 matrix; and the entries of w⁽ⁿ⁾ are independent identically distributed (i.i.d.) CN (0,N₀) (i.e., normally distritubted with mean 0 and variance N₀). The vector sₙ is the transmit vector in the nth subcarrier; Θₙ is the transmit beamforming in the nth subcarrier; and Pₙ, where Pₙ=Pₙ^{1/2} Pₙ^{1/2}, is a diagonal matrix where the diagonal elements are the allocated powers for the corresponding beam. K data streams are transmitted simultaneously, sₙ is a K×1 vector and Θₙ is a Mₜ×K matrix. In order to keep the maximum total transmit on Mₜ antennas at one symbol time to P₀, the transmit signal is normalized as:

$$trace ( {\sum }_{n = 0}^{N - 1} {( {Θ}_{n} {P}_{n}^{1 / 2} )}^{H} {Θ}_{n} {P}_{n}^{1 / 2} ) = {P}_{0} \qquad ( 2 )$$

The singular value decomposition (SVD) of Hₙ is:

Hₙ=UₙΛₙVₙ^{H}, (3)

the optimal transmit beamforming matrix Θₙ is:

Θₙ=Vₙ(:,1:K) (4)

and the receive beamforming matrix, Ωₙ, is given as:

Ωₙ=Uₙ(:,1:K). (5)

where Vₙ (:,1:K) and Uₙ (:,1:K) are the first K columns of the Vₙ and Uₙ matrix, which correspond to the K strongest right and left eigenvectors of Hₙ.

With this transmit beamforming and receive beamforming, the estimation of the transmit signal, s, is:

$${s}^{⋒} = \sqrt{\frac{{E}_{s}}{{M}_{t}}} {Λ}_{n} {P}_{n}^{1 / 2} {s}_{n} + {\tilde{w}}_{n} . \qquad ( 6 )$$

where \tilde{w}ₙ=U(:,1:K)^{H}wₙ.

In an exemplary embodiment in accordance with this invention, the minimum information BLER can be achieved based on EESM. With the EESM scheme the effective SINR can be obtained. Since information BLER is a monotone decreasing function, along with effective SINR in the concerned region, the maximization of the effective SINR is equivalent to the minimization of the information BLER. See S. Tsai, and A Soong, “Effective SNR mapping for modeling frame error rates in multiple-state channels”, 3GPP2-C30-20030429-010, 2003.

Therefore, in an exemplary embodiment in accordance with this invention, the minimization of information BLER can be achieved.

Information BLER can be predicted by

$$BLER = f ( {SINR}_{eff} ) \\ where \\ {SINR}_{eff} = - β ln [ \frac{1}{NK} {\sum }_{k = 0}^{K - 1} {\sum }_{n = 0}^{N - 1} exp ( - \frac{{SINR}_{n}^{( k )}}{β} ) ] , \qquad ( 7 )$$

and SINRₙ^{(k)} is the SINR at the nth subcarrier for the kth stream. The scaling factor β allows adjusting the compressing function in a way that the mismatch between actual BLER and the predicted BLER is minimized.

The function ƒ( ) is the same function as the function of BLER vs. SINR under additive white Gaussian noise (AWGN) channel. This function is a monotone decreasing function. As a result, maximizing the effective SIN_{eff} is equivalent to minimizing the information BLER.

The SINR at the nth subcarrier for the kth stream, taking into account joint beamforming, can be expressed as:

$${SINR}_{n}^{( k )} = \frac{{{E}_{s} ( {λ}_{n}^{( k )} )}^{2} {p}_{n}^{( k )}}{{M}_{- t} {N}_{0}} \qquad ( 8 )$$

Therefore the final SINR depends on the channel through the gain, λₙ^{(k)}, and on the allocated power, pₙ^{(k)}. Hence, the optimum allocation power can be obtained by:

$${{p}^{⋒}}_{n}^{( k )} = arg {max}_{{p}_{n}^{( k )}} \{ - β ln [ \frac{1}{NK} {\sum }_{k = 0}^{K - 1} {\sum }_{n = 0}^{N - 1} exp ( - \frac{{{E}_{s} ( {λ}_{n}^{( k )} )}^{2} {p}_{n}^{( k )}}{β {M}_{t} {N}_{0}} ) ] \} \qquad ( 9 )$$

At the same time, the global power constraint is expressed as

$$\begin{matrix}{\sum }_{k = 0}^{K - 1} {\sum }_{n = 0}^{N - 1} {p}_{n}^{( k )} = {P}_{0} \\ and & ( 10 ) \\ {p}_{n}^{( k )} \geq 0 , where n = 0 , … , N - 1 and k = 0 , … , K - 1 & ( 11 )\end{matrix}$$

Since the ln( ) function is a monotone function, the maximization of −ln(x) is equivalent to the minimization of x. Hence, eq. (9) may be changed into

$${{p}^{⋒}}_{n}^{( k )} = arg {min}_{{p}_{n}^{( k )}} \{ \frac{1}{NK} {\sum }_{k = 0}^{K - 1} {\sum }_{n = 0}^{N - 1} exp ( - \frac{{{E}_{s} ( {λ}_{n}^{( k )} )}^{2} {p}_{n}^{( k )}}{β {M}_{t} {N}_{0}} ) \}$$

As a result, the Lagrange multipliers can be expressed as:

$$\begin{matrix}{L}_{p} = \frac{1}{NK} {\sum }_{k = 0}^{K - 1} {\sum }_{n = 0}^{N - 1} exp ( - {μ}_{n}^{( k )} {p}_{n}^{( k )} ) + λ ( {\sum }_{k = 0}^{K - 1} {\sum }_{n = 0}^{N - 1} {p}_{n}^{( k )} - {P}_{0} ) \\ where & ( 12 ) \\ {μ}_{n}^{( k )} = \frac{{{E}_{s} ( {λ}_{n \cdot }^{( k )} )}^{2}}{β {M}_{t} {N}_{0}} & ( 13 )\end{matrix}$$

The stationary points may be found by setting the derivative of Lₚ equal to zero,

$$\frac{σ {L}_{p}}{{p}_{n}^{( k )}} = - \frac{{μ}_{n}^{( k )}}{NK} exp ( - {μ}_{n}^{( k )} {p}_{n}^{( k )} ) + λ = 0 \qquad ( 14 )$$

From eq. (14):

$${p}_{n}^{( k )} = \frac{- 1}{{μ}_{n}^{( k )}} ln ( \frac{NK λ}{{μ}_{n}^{( k )}} ) \qquad ( 15 )$$

Combined with eq. (10):

$${\sum }_{k = 0}^{K - 1} {\sum }_{n = 0}^{N - 1} \frac{- 1}{{μ}_{n}^{( k )}} ln ( \frac{NK λ}{{μ}_{n}^{( k )}} ) = {P}_{0} \\ ⇒ {\sum }_{k = 0}^{K - 1} {\sum }_{n = 0}^{N - 1} \frac{- 1}{{μ}_{n}^{( k )}} ( ln ( \frac{NK}{{μ}_{n}^{( k )}} ) + ln ( λ ) ) = {P}_{0} \\ ⇒ {\sum }_{k = 0}^{K - 1} {\sum }_{n = 0}^{N - 1} \frac{- 1}{{μ}_{n}^{( k )}} ( ln ( \frac{NK}{{μ}_{n}^{( k )}} ) ) + ln ( λ ) \times {\sum }_{k = 0}^{K - 1} {\sum }_{n = 0}^{N - 1} \frac{- 1}{{μ}_{n}^{( k )}} = {P}_{0} \\ ⇒ λ = exp ( \frac{1}{- {\sum }_{k = 0}^{K - 1} {\sum }_{n = 0}^{N - 1} \frac{- 1}{{μ}_{n}^{( k )}}} ( {P}_{0} + {\sum }_{k = 0}^{K - 1} {\sum }_{n = 0}^{N - 1} \frac{- 1}{{μ}_{n}^{( k )}} ( ln ( \frac{NK}{{μ}_{n}^{( k )}} ) ) ) ) \qquad ( 16 )$$

Hence, the optimal λ is:

$${λ}^{*} = exp ( \frac{1}{- {\sum }_{k = 0}^{K - 1} {\sum }_{n = 0}^{N - 1} \frac{- 1}{{μ}_{n}^{( k )}}} ( {P}_{0} + {\sum }_{k = 0}^{K - 1} {\sum }_{n = 0}^{N - 1} \frac{1}{{μ}_{n}^{( k )}} ln ( \frac{NK}{{μ}_{n}^{( k )}} ) ) ) \qquad ( 17 )$$

As a result,

$${p}_{n}^{( k )} = {( - \frac{1}{{μ}_{n}^{( k )}} ( ln ( \frac{NK}{{μ}_{n}^{( k )}} ) + ln ( {λ}^{*} ) ) )}_{+} , \qquad ( 18 )$$

where the function (x)₊:=max (x,0). Thus, the closed-form for power allocation may be obtained.

As seen above, the optimized power to minimize the information BLER may be given as:

$${p}_{n}^{( k )} = {( - \frac{1}{{μ}_{n}^{( k )}} ( ln ( \frac{NK}{{μ}_{n}^{( k )}} ) + ln ( {λ}^{*} ) ) )}_{+} \\ where \\ {μ}_{n}^{( k )} = \frac{{{E}_{s} ( {λ}_{n}^{( k )} )}^{2}}{β {M}_{t} {N}_{0}} , \\ {λ}^{*} = exp ( \frac{1}{- {\sum }_{k = 0}^{K - 1} {\sum }_{n = 0}^{N - 1} \frac{- 1}{{μ}_{n}^{( k )}}} ( {P}_{0} + {\sum }_{k = 0}^{K - 1} {\sum }_{n = 0}^{N - 1} \frac{- 1}{{μ}_{n}^{( k )}} ln ( \frac{NK}{{μ}_{n}^{( k )}} ) ) ) , \qquad ( 19 )$$

and β is a adjust factor in EESM, which can be obtained by simulation. The value of β is independent of channel, and only decided by the MCS. λₙ^{(k)} (k=0, . . . K−1) are the first K strongest diagonal elements of Λₙ.

An exemplary embodiment in accordance with this invention is a method for allocating power for beamforming. A SS estimates the channel matrix, Hₙ, from pilots and/or midamble. The SS computes and feedbacks the beamforming matrices, Vₙ and Λₙ. If the SS knows beforehand that the BS only employs K spatial data streams, the SS may feedback only the first K columns of the Vₙ matrix, which corresponds to the K strongest eigenmodes of Hₙ, and the first K diagonal elements of Λₙ, which corresponds to the K strongest eigenvalues.

According to the channel state information, the BS selects a MCS and the adjust parameter β accordingly. Meanwhile, the BS decides the number of streams. The BS allocates power for K streams in each used subcarrier according to eq. (19) and takes Vₙ (:,1 :K), corresponding to the K strongest right eigenvectors of Hₙ, as the beam.

FIG. 4 is a logic flow diagram of an exemplary method in accordance with this invention. The method provides for allocating power for beamforming. At block 400, the method includes selecting a number of data streams to be employed for the beamforming. Power for beamforming is allocated to the selected number of data streams based upon the effective SINR and in consideration of a FEC code in block 410.

The allocation of power may be based upon maximizing the effective SINR. The method may include selecting a MCS based upon channel state information. An adjust parameter is selecting based upon the MCS and power allocating is also based upon the selected adjust parameter. Additionally, the method may include determining an effective SINR using an EESM procedure.

Furthermore, the method may include receiving an indication of a beamforming matrix. Channel state information may be determined from the received indication. The effective SINR is based upon the channel state information. The indication of the beamforming matrix may include the K strongest eigenmodes and the K strongest eigenvalues of the beamforming matrix, where K is the number of data streams employed. The allocating of power may also be based upon the K strongest eigenvectors of the beamforming matrix.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, Calif., automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
selecting a number of data streams to be employed for beamforming; and
allocating power for beamforming to the selected number of data streams based upon an effective signal to noise and interference ratio and in consideration of a forward error correct code.

2. The method of claim 1, wherein allocating power is further based upon maximizing the effective signal to noise and interference ratio.

3. The method of claim 2, wherein a block error rate is minimized as a result of the maximizing of the effective signal to noise and interference ratio.

4. The method of claim 1, further comprising:
selecting a modulation and coding scheme based upon channel state information; and
selecting an adjust parameter based upon the selected modulation and coding scheme, wherein determining power is further based upon the selected adjust parameter.

5. The method of claim 4, wherein the adjust parameter is independent of channels being used and is selected based upon a simulation.

6. The method of claim 4, wherein the forward error code is at least one of turbo code, convolutional code and low density parity check code

7. The method of claim 1, further comprising:
receiving an indication of a beamforming matrix; and
determining channel state information from the received indication,
wherein the effective signal to noise and interference ratio is based upon the channel state information.

8. The method of claim 7, wherein the indication of the beamforming matrix comprises K strongest eigenmodes and K strongest eigenvalues of the beamforming matrix, where K is the number of data streams employed.

9. The method of claim 1, wherein allocating power is based upon K strongest eigenvectors of a beamforming matrix, where K is the number of data streams employed.

10. The method of claim 1, performed in a multi-input multi-output orthogonal frequency division multiplexing system.

11. The method of claim 1, further comprising determining an effective signal to noise and interference ratio using an exponential effective signal to noise and interference ratio mapping procedure.

12. An apparatus comprising:
a component configured to select a number of data streams to be employed for beamforming; and
a power allocating component configured to allocate power for beamforming to the selected number of data streams based upon the effective signal to noise and interference ratio and in consideration of a forward error correct code.

13. The apparatus of claim 12, wherein the power allocating component is further configured to allocate power based upon maximizing the effective signal to noise and interference ratio.

14. The apparatus of claim 12, further comprising:
a receiver configured to receive an indication of a beamforming matrix; and
a channel state determining component configured to determine channel state information from the received indication,
wherein the effective signal to noise and interference ratio is based upon the channel state information.

15. The apparatus of claim 12, comprises a part of a multi-input multi-output orthogonal frequency division multiplexing system.

16. The apparatus of claim 12, wherein the apparatus is embodied in one or more integrated circuits.

17. An apparatus comprising:
means for selecting a number of data streams to be employed for beamforming; and
means for allocating power for beamforming to the selected number of data streams based upon the effective signal to noise and interference ratio and in consideration of a forward error correct code.

18. The apparatus of claim 17, wherein the determining means is a processor and the allocating means is a processor.

19. A computer readable medium embodied with a computer program comprising program instructions, execution of the program instructions resulting in operations comprising:
selecting a number of data streams to be employed for beamforming; and
allocating power for beamforming to the selected number of data streams based upon the effective signal to noise and interference ratio and in consideration of a forward error correct code.

20. The computer readable medium of claim 19, wherein allocating power is further based upon maximizing an effective signal to noise and interference ratio.

21. The computer readable medium of claim 19, wherein the operations further comprise:
selecting a modulation and coding scheme based upon channel state information; and
selecting an adjust parameter based upon the selected modulation and coding scheme, wherein allocating power is further based upon the selected adjust parameter.

22. The computer readable medium of claim 21, wherein the forward error code is at least one of turbo code, convolutional code and low density parity check code.

23. The computer readable medium of claim 19, wherein the operations further comprise:
receiving an indication of a beamforming matrix; and
determining channel state information from the received indication,
wherein the effective signal to noise and interference ratio is based upon the channel state information.

24. A system comprising:
a mobile station, wherein the mobile station comprises:
a channel matrix estimating component configured to estimate a channel matrix;
a beamforming matrix generating component configured to generate a beamforming matrix based upon the channel matrix; and
a transmitter configured to transmit an indication of the beamforming matrix; and
a network element comprising:
a receiver configured to receive the indication of the beamforming matrix;
and
a channel state determining component configured to determine channel state information from the received indication,
a component configured to select a number of data streams to be employed for beamforming; and
a power allocating component configured to allocate power for beamforming based upon the effective signal to noise and interference ratio and in consideration of a forward error correct code; wherein the effective signal to noise and interference ratio is based upon the channel state information.

25. The system of claim 24, wherein the indication of the beamforming matrix comprises K strongest eigenmodes and K strongest eigenvalues of the beamforming matrix, where K is the number of data streams employed.
